(19) United States
(12) Patent Application Publication
(10) Pub. No.: US 2015/0332192 A1
(43) Pub. Date: Nov. 19, 2015

(54) Estimating Future Inventory

(71) Applicant: Google Inc., Mountain View, CA (US)

(72) Inventor: Jonathan Harel, Los Angeles, CA (US)

(21) Appl. No.: 14/597,355

(22) Filed: Jan. 15, 2015

(30) Foreign Application Priority Data
May 15, 2014 (IL) 232640

(51) Int. Cl. G06Q 10/06; G06Q 30/02

(52) U.S. Cl. CPC G06Q 10/06315; G06Q 30/0277

(57) ABSTRACT

Methods, systems, and apparatus include computer programs encoded on a computer-readable storage medium for estimating performance parameters. A method includes: identifying selection criteria including one or more words, phrases or categories for use in a campaign; identifying a time in the future; estimating one or more performance parameters associated with execution of the campaign at the time in the future including for each performance parameter: identifying a time series based on historical inventory for the performance parameter; identifying and correcting for discontinuities in the time series to produce a corrected time series; evaluating the corrected time series for periodic components; evaluating the corrected time series for trends; extrapolating the corrected time series into the future based on the evaluating for periodic components and trends; and determining, for the time, estimated values for the performance parameter; and providing the estimated values for the one or more performance parameters.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Slots can be allocated to content sponsors through a reservation system or an auction. For example, content sponsors can provide bids specifying amounts that the sponsors are respectively willing to pay for presentation of their content. In turn, a reservation can be made or an auction can be performed, and the slots can be allocated to sponsors according, among other things, to their bids and/or the relevance of the sponsored content to content presented on a page hosting the slot or a request that is received for the sponsored content.

### SUMMARY

In general, one innovative aspect of the subject matter described in this specification can be implemented in methods that include a method for estimating performance parameters. The method includes: identifying selection criteria including one or more words, phrases or categories for use in a campaign; identifying a time in the future; estimating one or more performance parameters associated with execution of the campaign at the time in the future including for each performance parameter: identifying a time series based on historical inventory for the performance parameter; identifying and correcting for discontinuities in the time series to produce a corrected time series; evaluating the corrected time series for periodic components; evaluating the corrected time series for trends; extrapolating the corrected time series into the future based on the evaluating for periodic components and trends; and determining, for the time, estimated values for the performance parameter; and providing the estimated values for the one or more performance parameters.

In general, another aspect of the subject matter described in this specification can be implemented in computer program products. A computer program product is tangibly embodied in a computer-readable storage device and comprises instructions. The instructions, when executed by a processor, cause the processor to: identify selection criteria including one or more words, phrases or categories for use in a campaign; identify a time in the future; estimate one or more performance parameters associated with execution of the campaign at the time in the future including for each performance parameter: identifying a time series based on historical inventory for the performance parameter; identifying and correcting for discontinuities in the time series to produce a corrected time series; evaluating the corrected time series for periodic components; evaluating the corrected time series for trends; extrapolating the corrected time series into the future based on the evaluating for periodic components and trends; and determining, for the time, estimated values for the performance parameter; and provide the estimated values for the one or more performance parameters.

In general, another aspect of the subject matter described in this specification can be implemented in systems. A system includes one or more processors and one or more memory elements including instructions. The instructions, when executed, cause the one or more processors to: identify selection criteria including one or more words, phrases or categories for use in a campaign; identify a time in the future; estimate one or more performance parameters associated with execution of the campaign at the time in the future including for each performance parameter: identifying a time series based on historical inventory for the performance parameter; identifying and correcting for discontinuities in the time series to produce a corrected time series; evaluating the corrected time series for periodic components; evaluating the corrected time series for trends; extrapolating the corrected time series into the future based on the evaluating for periodic components and trends; and determining, for the time, estimated values for the performance parameter; and provide the estimated values for the one or more performance parameters.

These and other implementations can each optionally include one or more of the following features. Identifying the selection criteria and the time can include receiving the selection criteria and the time from a content sponsor associated with the campaign. Identifying the time can include identifying a time period associated with the time including a starting time and an ending time. The time in the future can be not near term and can be substantially two to twelve months in the future. The one or more performance parameters can include a number of impressions and number of unique users associated with the impressions. Identifying a time series can include evaluating a historical log, determining for each performance parameter a value for a respective time unit associated with the series, and repeating the determining for a predetermined time period in the past. The time unit can be one day. Identifying discontinuities can include comparing adjacent portions of the time series for differences as compared by a measure of improbability with respect to the differences. The measure of improbability can be a measure of both a magnitude and abruptness of the difference. Evaluating the corrected time series for periodic components can include identifying portions of the corrected time series that include periodic changes in values for the performance parameter and determining a period and change level to be attributed to the period. Evaluating the corrected time series for trends can include determining a recent trend based on changes in values for the performance parameter in a recent past and determining a rate of change based on the recent trend. The selection criteria can be attributes associated with one or more of targeted users or impressions. Evaluating the corrected time series for periodic components can include identifying periodic signals in the corrected time series, characterized by period and temporal span within each period and having statistical significance. Evaluating the corrected time series for trends can include identifying a trend signal that represents a non-periodic increase or decrease over time. Extrapolating the corrected time series into the future can include extending each periodic signal and the trend signal in the corrected time series. One or more regression parameters can be applied to combine extended basis vectors based on the periodic and trends signals into a resultant time series which projects out into the future.

Particular implementations may realize none, one or more of the following advantages. A content sponsor can be provided with campaign performance estimates for a non-near time in the future. A content sponsor can be provided with campaign performance estimates that are determined and/or adjusted based on discontinuities, periodic components and trend components located in historical data. A content sponsor can be notified regarding a seasonality effect on a campaign performance estimate.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for presenting content.

FIG. 2 is a block diagram of an example system for estimating performance parameters.

FIG. 3 is a flowchart of an example process for estimating performance parameters.

FIG. 4A is a graph of a time series which includes a discontinuity.

FIG. 4B is a graph of a corrected time series.

FIG. 5 is a block diagram of computing devices that may be used to implement the systems and methods described in this document, as either a client or as a server or plurality of servers.

Like reference numbers and designations in the various drawings indicate like elements.

### DETAILED DESCRIPTION

One or more performance parameters (e.g., number of impressions, number of unique users) for a content campaign can be estimated for a specified time in the future, such as a time that is two or more months in the future. A set of estimation steps can be performed for each performance parameter. For example, for a given performance parameter, a time series for the performance parameter can be identified based on historical data (e.g., historical inventory data). Discontinuities in the time series can be identified and corrected to produce a corrected time series and the corrected time series can be evaluated for periodic components and trends. The corrected time series can be extrapolated into the future, based on the evaluating for periodic components and trends. Estimated values for the performance parameter can be determined for the time in the future. The set of estimation steps can be repeated for one or more other performance parameters. When the estimation steps have been performed for each performance parameter, the estimated values for the one or more performance parameters can be provided, such as to a sponsor associated with the campaign.

For situations in which the systems discussed here collect information about users, or may make use of information about users, the users may be provided with an opportunity to control whether programs or features collect user information (e.g., information about a user's social network, social actions or activities, profession, demographics, a user's preferences, or a user's current location), or to control whether and/or how to receive content from a content server that may be more relevant to the user. In addition, certain data may be treated in one or more ways before it is stored or used, so that certain information about the user is removed. For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information about the user is collected and used by a content server.

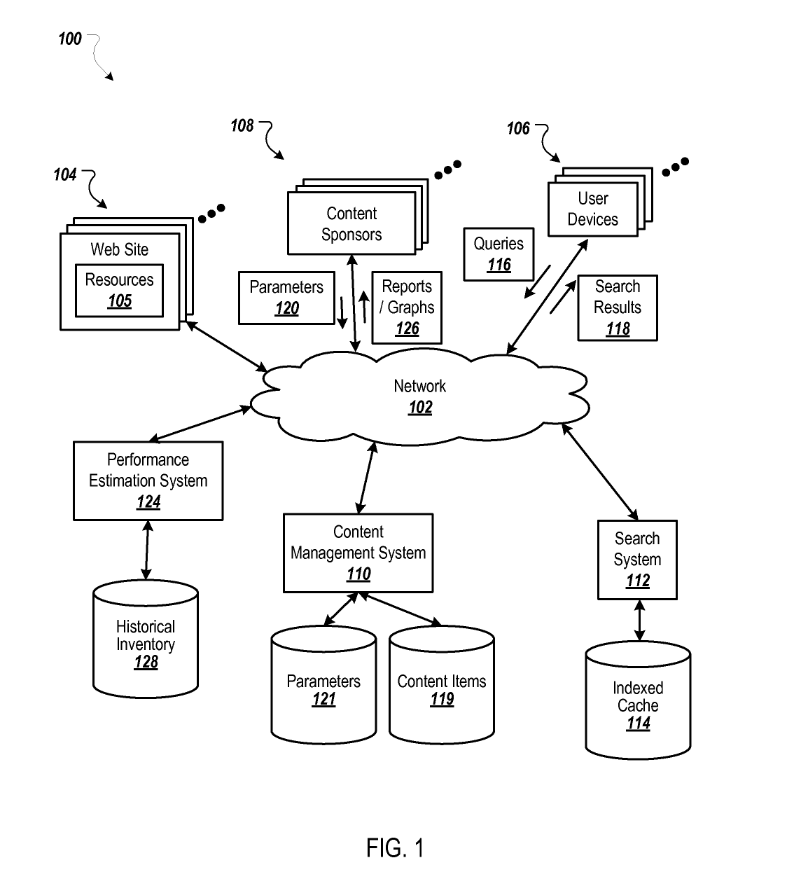

FIG. 1 is a block diagram of an example environment 100 for presenting content. The example environment 100 includes a network 102, such as a local area network (LAN), a wide area network (WAN), the Internet, or a combination thereof. The network 102 connects websites 104, user devices 106, content sponsors 108, publishers, and a content management system 110. The example environment 100 may include many thousands of websites 104, user devices 106, content sponsors 108, and publishers. The content management system 110 may be used for selecting and providing content in response to requests for content. The content sponsors 108 can be, for example, advertisers. Other types of content sponsors are possible.

A website 104 includes one or more resources 105 associated with a domain name and hosted by one or more servers. An example website 104 is a collection of web pages formatted in hypertext markup language (HTML) that can contain text, images, multimedia content, and programming elements, such as scripts. Each website 104 can be maintained by a publisher, which is an entity that controls, manages and/or owns the website 104.

A resource 105 can be any data that can be provided over the network 102. A resource 105 can be identified by a resource address that is associated with the resource 105. Resources 105 include HTML pages, word processing documents, portable document format (PDF) documents, images, video, and news feed sources, to name only a few. The resources 105 can include content, such as words, phrases, videos, images and sounds, that may include embedded information (such as meta-information hyperlinks) and/or embedded instructions (such as scripts).

A user device 106 is an electronic device that is under control of a user and is capable of requesting and receiving resources 105 over the network 102. Example user devices 106 include personal computers, tablet computers, mobile communication devices (e.g., smartphones), televisions, set top boxes, personal digital assistants and other devices that can send and receive data over the network 102. A user device 106 typically includes one or more user applications, such as a web browser, to facilitate the sending and receiving of data over the network 102. The web browser can interact with various types of web applications, such as a game, a map application, or an e-mail application, to name a few examples.

A user device 106 can request resources 105 from a website 104. In turn, data representing the resource 105 can be provided to the user device 106 for presentation by the user device 106. User devices 106 can also submit search queries 117 to the search system 115 over the network 102. In response to a search query 117, the search system 115 can, for example, access the indexed cache 116 to identify resources 105 that are relevant to the search query 117. The search system 115 identifies the resources 105 in the form of search results 118 and returns the search results 118 to the user devices 106 in search results pages. A search result 118 is data generated by the search system 115 that identifies a resource 105 that is responsive to a particular search query 117, and can include a link to the resource 105. An example search result 118 can include a web page title, a snippet of text or a portion of an image extracted from the web page, and the URL (Unified Resource Location) of the web page.

The data representing the resource 105 or the search results 118 can also include data specifying a portion of the resource 105 or search results 118 or a portion of a user display (e.g., a presentation location of a pop-up window or in a slot of a web page) in which other content (e.g., advertisements) can be presented. These specified portions of the resource or user display are referred to as slots or impressions. An example slot is an advertisement slot.

When a resource 105 or search results 118 are requested by a user device 106, the content management system 110 may receive a request for content to be provided with the resource 105 or search results 118. The request for content can include characteristics of one or more slots or impressions that are defined for the requested resource 105 or search results 118. For example, a reference (e.g., URL) to the resource 105 or search results 118 for which the slot is defined, a size of the slot, and/or media types that are available for presentation in the slot can be provided to the content management system 110. Similarly, keywords associated with a requested resource 105 or a search query 117 for which search results 118 are requested can also be provided to the content management system 110 to facilitate identification of content that is relevant to the resource 105 or search query 117. An identifier (e.g., cookie) associated with the user device 106 can be received with the request for content.

Based, for example, on data included in the request for content, the content management system 110 can select content items that are eligible to be provided in response to the request (e.g., from a content items datastore 119). One or more selected content items can be provided to the user device 106 in association with providing an associated resource 105 or search results 118. The provided content item(s) can be presented on the user device 106, in one or more respective slots.

The content management system 110 can, for example, select a content item having characteristics matching the characteristics of a given slot. As another example, content items having selection criteria (e.g., keywords) that match resource keywords in the search query 117 or keywords included in the search results 118 may be selected as eligible content items by the content management system 110. As yet another example, the content management system 110 can identify a content item that is associated with a keyword that matches a keyword included in a user profile associated with the requesting user device 106.

In some implementations, the content management system 110 can select content items based at least in part on results of an auction. For example, content providers 108 can provide bids specifying amounts that the content providers 108 are respectively willing to pay for presentation of their content items. In turn, an auction can be performed and the slots can be allocated to content providers 108 according, among other things, to their bids and/or the relevance of a content item to content presented on a page hosting the slot or a request that is received for the content item. For example, when a slot is being allocated in an auction, the slot can be allocated to the content provider 108 that provided the highest bid or a highest auction score (e.g., a score that is computed as a function of a bid and/or a quality measure). A quality score can be determined, for example, based on a quality of match between, for example, a keyword associated with a content item and keywords associated with a resource that includes the slot associated with the request. As another example, a quality score can be determined based on a quality of match between a keyword associated with a content item and keywords included in a user device profile associated with the requesting user device 106. One or more selected content items can be provided to the user device 106 in association with providing an associated resource 105 or search results 118. The provided content item(s) can be presented on the user device 106, in one or more respective slots.

A content sponsor 108 can create a content campaign associated with one or more content items using tools provided by the content management system 110. For example, the content management system 110 can provide one or more account management user interfaces for creating and managing content campaigns. The account management user interfaces can be made available to the content sponsor 108, for example, either through an online interface provided by the content management system 110 or as an account management software application installed and executed locally at a content sponsor's client device.

A content sponsor 108 can, using the account management user interfaces, provide campaign parameters 120 which define a content campaign. The content campaign can be created and activated for the content sponsor 108 according to the parameters 120 specified by the content sponsor 108. The campaign parameters 120 can be stored in a campaign database 121. Campaign parameters 120 can include, for example, a campaign name, a preferred content network for placing content, a budget for the campaign, start and end dates for the campaign, a schedule for content placements, content (e.g., creatives), bids, and selection criteria. Selection criteria can include, for example, a language, one or more geographical locations or websites, and/or one or more selection terms. The selection terms, can include, for example, one or more keywords. The selection terms can be used in evaluating when to serve content items in response to received requests for content.

A content sponsor 108 may desire to know estimates for performance parameters, such as for a currently-running, recently-created, or potential campaign. For example, the content sponsor 108 may desire to know a number of impressions for the campaign and/or to know how many unique users may be served content associated with the campaign. The content sponsor 108 may desire to know performance parameter estimates for the near and/or non-near term. A near-term estimate may be, for example, an estimate for a time one week from the current date. A non-near term estimate may be, for example, an estimate for a time ten months from the current date.

The content sponsor 108 can interact with a performance estimation system 124 to receive performance parameter estimates. For example, the content sponsor 108 can provide selection criteria and a time (or time period) in the future to the performance estimation system 124. The performance estimation system 124 can determine performance parameter estimates associated with the selection criteria for the time in the future and can provide the determined estimates to the content sponsor 108, such as in one or more reports and/or graphs 126.

The content sponsor 108 may desire to experiment with receiving different estimates, for different times (or time periods) in the future and for different selection criteria associated with one or more currently-running, recently-created, or potential campaigns. Content sponsors 108 in general may provide many different times (or periods) in the future and one or more different selection criteria. The performance estimation system 124 may not know in advance what type of selection criteria and which times in the future may be provided. The performance estimation system 124 can be configured to determine a performance parameter estimate on demand, for selection criteria and a time (or time period) in the future that the content sponsor 108 may choose to provide, rather than pre-computing or pre-processing an estimate. The performance estimation system 124 can be configured to provide the on-demand estimate in a time equal to or less than a threshold time, such as in real-time and in less than one second.

The performance estimation system 124 can receive, from the content sponsor 108, an indication of which performance parameters to estimate, or the performance estimation system 124 can identify one or more predetermined performance parameters to estimate (such as by selecting one or more underperforming parameters associated with a given campaign). The performance estimation system 124 can perform a set of estimation steps for each identified performance parameter. For example, for a given performance parameter, the performance estimation system 124 can identify a time series for the performance parameter, such as based on historical inventory 128. The historical inventory 128 can include, for example, impression information for historical impressions. The performance estimation system 124 can evaluate the historical inventory 128 to identify an example time series for the performance parameter, such as by determining a value for the performance parameter for each respective time unit in the time series. A time unit can be, for example, one day.

The performance estimation system 124 can identify discontinuities in the time series and can correct the discontinuities to produce a corrected time series. The performance estimation system 124 can evaluate the corrected time series for periodic components and trends. Discontinuities, periodic components, and trends are discussed in more detail below.

The performance estimation system 124 can extrapolate the corrected time series into the future, based on the evaluating for periodic components and trends. The performance estimation system 124 can determine estimated values for the performance parameter for the time in the future. The set of estimation steps can be repeated by the performance estimation system 124 for other identified performance parameters (if any). When the estimation steps have been performed for each identified performance parameter, the performance estimation system 124 can provide the estimated values for performance parameter(s) to the requesting entity (e.g., the content sponsor 108), such as in association with the reports and/or graphs 126.

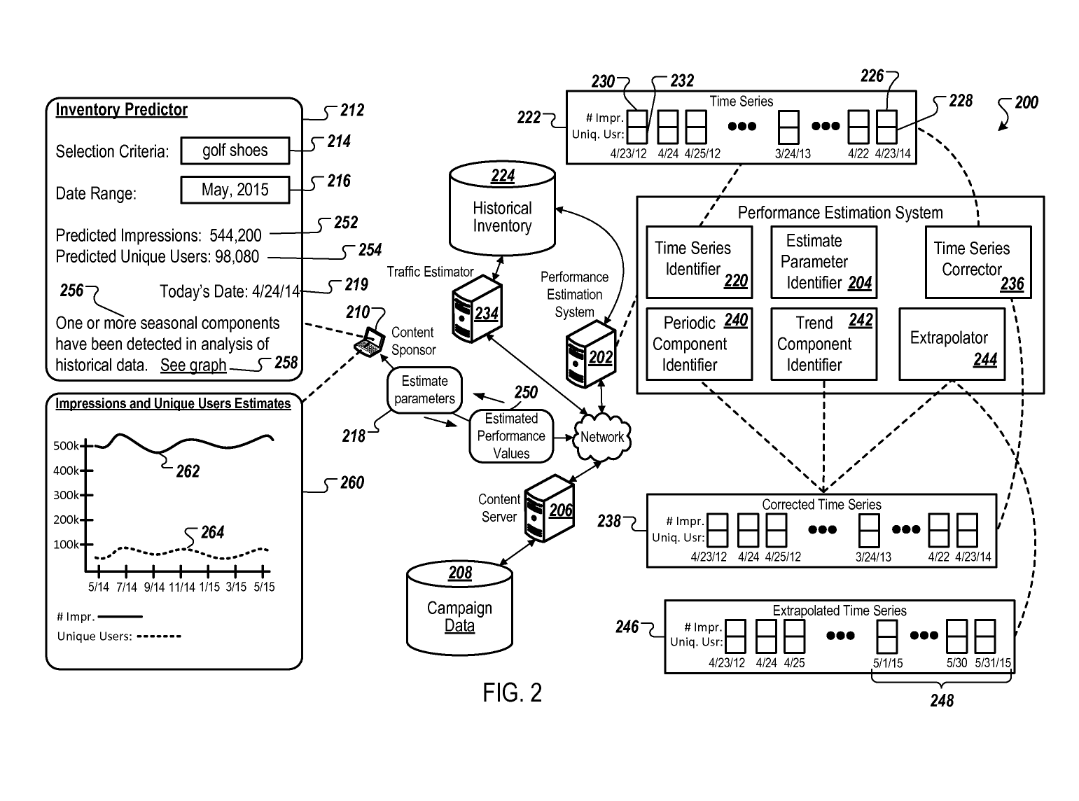

FIG. 2 is a block diagram of an example system 200 for estimating performance parameters. A performance estimation system 202 can determine estimated performance values for a content sponsor. For example, an estimate parameter identifier 204 included in the performance estimation system 202 can identify estimate parameters such as selection criteria associated with the content sponsor and a time or time period in the future for which to determine performance estimates.

For example, the estimate parameter identifier 204 can automatically identify estimate parameters. For example, the performance estimation system 202 can periodically (e.g., weekly) determine performance estimates for the content sponsor, such as part of an opportunity system for notifying the content sponsor of opportunities of interest. The estimate parameter identifier 204 can, for example, query a content server 206 for selection criteria associated with a campaign of the content sponsor. The content sponsor 202 can, for example, retrieve selection criteria associated with the content sponsor from a campaign data database 208 and provide the selection criteria to the estimate parameter identifier 204. Although the performance estimation system 202 and the content server 206 are shown as separate systems, in some implementations, some or all of the features of the performance estimation system 202 and the content server 206 are implemented in a single system.

As another example, the estimate parameter identifier 204 can receive estimate parameters from a content sponsor device 210. For example, an inventory predictor user interface 212 can be displayed on the content sponsor device 210. The content sponsor can provide selection criteria (e.g., using a selection criteria input control 214) and a date range in the future (e.g., using a date range input control 216). The selection criteria (e.g., “golf shoes”) and the date range (e.g., “May, 2015”) can be provided to the estimate parameter identifier 204, such as illustrated by provided estimate parameters 218. The date range of May, 2015 in the example of FIG. 2 is more than a year from a current date 219 of Apr. 24, 2014.

A time series identifier 220 included in the performance estimation system 202 can identify a time series 222. The time series identifier 220 can identify a series of values for one or more performance parameters. For example, the time series 222 includes a series of values for impressions and unique users. Although illustrated as a single time series 222 associated with two performance parameters, the time series identifier 220 can identify multiple time series for a content sponsor, such as one time series for each performance parameter. To identify the time series 222, the time series identifier 220 can evaluate a historical inventory database 224. The historical inventory database 224 is a historical log, such as of impressions and other data.

The time series identifier 220 can evaluate the historical inventory 224 to determine a first value for impressions and a second value for unique users for a time unit (e.g., one day) based on the identified or received selection criteria. The time series identifier 220 can repeat the evaluating of the historical inventory 224 for each time unit (e.g., day) in a predetermined historical time period. For example, when the current date is, for example, Apr. 24, 2014, the time series identifier 220 can determine a first value 226 for impressions and a second value 228 for unique users for the previous day (e.g., Apr. 23, 2014). The time series identifier 220 can determine a first value for impressions and a second value for unique users for each other day in, for example, a two year historical time period before the current date, up to and including a first value 230 for impressions and a second value 232 for unique users for Apr. 23, 2012. Other historical time periods can be used, including those that do not terminate on the current date.

In some implementations, rather than evaluating the historical inventory 224, the time series identifier 220 queries a traffic estimator 234 for performance parameter values for days in the time series 222. The time series identifier 220 and/or the traffic estimator 234 can be configured to meet a timing goal of determining performance parameter values for the time series 222 in less than a threshold time, such as to provide an acceptable response time for the content sponsor when the content sponsor uses the inventory predictor user interface 212. Although illustrated as a single server, the traffic estimator 234 can be implemented across multiple servers to meet the timing goal. Other approaches for meeting the timing goal can include using indexing or sub sampling the historical inventory 224.

A time series corrector 236 included in the performance estimation system 202 can identify and correct for discontinuities in the time series 222 to produce a corrected time series 238. Discontinuities can exist in the time series 222 due to one or more reasons. For example, discontinuities can exist due to a change in a classification algorithm or system. For example, a classification algorithm or system change can result in a change to how selection criteria are associated with particular impressions. As another example, a classification algorithm can change a distribution of verticals (e.g., semantic markers, such as topics) used for classification. As yet another example, discontinuities can occur in response to changes in the number of content sponsors served by the content server 206 or changes in volume of content served by the content server 206. For example, a new, large group of inventory can be associated with the content server 206, such as due to new partnerships or business deals which affect inventory served by the content server 206.

To correct for discontinuities in the time series 222, the time series corrector 236 can compare adjacent portions of the time series 222 for differences as compared by a measure of improbability with respect to the differences (e.g., an improbability of observing one portion given the statistics of the adjacent portion and vice versa). The measure of improbability can be a measure of both a magnitude and abruptness of a respective difference. When the improbability is more than a threshold at a particular point in the time series 222, a discontinuity can be identified at that point. When one or more discontinuity points have been identified, two or more segments can be identified. For example, a segment can begin and/or end at a discontinuity point. The discontinuities can be corrected, for example, by subtracting out an average linear trend in each segment and applying a smoothing function at segment boundaries, to create the corrected time series 238. A result of the correction can be that the corrected time series 238 is free of sharp, discontinuous jumps.

A periodic component identifier 240 can evaluate the corrected time series 238 for periodic components. Evaluating for periodic components can include, for example, identifying period patterns in the corrected time series 238. For example, evaluating for periodic components can include identifying portions of the corrected time series 238 that include periodic changes in values for a performance parameter and determining a period and change level to be attributed to the period. As another example, evaluating for periodic components can include identifying periodic signals in the corrected time series 238, characterized by period and temporal span within each period and having statistical significance. In some implementations, the periodic component identifier 240 can generate a set of periodic basis vectors, with each periodic basis vector having a different period, offset, and specificity (e.g., width). For example, a first periodic basis vector may have a period of one week with one day specificity and correspond to a day-of-week variation. A second periodic basis vector may have a period of a calendar year with a 3-month specificity and correspond to seasonal variations. As another example, identifying candidate basis vectors for later regression may be carried out by finding local maxima in a goodness-of-fit function over a parameter space (e.g., offset, period, specificity).

A trend component identifier 242 can evaluate the corrected time series 238 for trends. Evaluating for trends can include, for example, identifying a signal in the corrected time series 238 that represents a non-periodic increase or decrease over time, based on fitting the corrected time series 238 to various temporal origins.

An extrapolator 244 can extrapolate the corrected time series 238 into the future based on the identified periodic component(s) and trend(s) to create an extrapolated time series 246. Extrapolating can include, for example, extending each periodic signal and trend signal identified in the corrected time series 238 to the extrapolated time series 246 until the extrapolated time series 246 includes the identified time in the future for which to estimate performance parameters (e.g., May, 2015 in the example of FIG. 2). For example, a rightmost portion 248 of the extrapolated time series 246 includes entries for each day of May, 2015. As another example, extrapolating can include applying one or more regression parameters to combine extended basis vectors based on the periodic and trends signals into the extrapolated time series 246.

The extrapolator 244 can determine an estimate for a performance parameter, such as by summing values for the performance parameter over entries in the extrapolated time series 246 that correspond to the received date range. For example, the extrapolator 244 can determine a first sum of impression values and a second sum of unique users values for the rightmost portion 248 of the extrapolated time series 246.

In some implementations, the extrapolator 244 determines an estimate for a performance parameter by using a multiplier. For example, the extrapolator 244 can determine a multiplier value for a performance parameter for a particular day in the rightmost portion 248 of the extrapolated time series 246 by determining a ratio of the value of the performance parameter on the particular day to the value of the performance parameter on the current date. In some implementations, the extrapolator 244 (or the time series identifier 220) can determine a value of the performance parameter on the current date by sampling data in the historical inventory 224 for the current date more densely than for other days in the time series 222 (e.g., to determine a estimate for the current date that may be more accurate than for other dates). When a multiplier is, for example, 1.1 for a particular day in the rightmost portion 248, the 1.1 multiplier value can indicate that the value of the performance parameter (e.g., impressions, unique users) on that day is 110% of the value for the current day. The extrapolator can use the multiplier values determined for each day of the rightmost portion 248 to determine the estimates for the performance parameters for the received date range.

The performance estimation system 202 can provide the determined performance parameters estimates (e.g., as estimated performance values 250) to the content sponsor device 210, for presentation in the inventory predictor user interface 212. For example, the inventory predictor user interface 212 includes a predicated impressions value 252 (e.g., 544, 200) and a predicted unique users value 254 (e.g., 98,080). In some implementations, the inventory predictor user interface 212 includes values for performance parameters (e.g., impressions, unique users) for the current date. In some implementations, the inventory predictor user interface 212 includes a message 256 (e.g., indicating that “one or more seasonal components have been detected in analysis of historical data”).

In some implementations, the inventory predictor user interface 212 includes a user interface control 258 (e.g., a link, or button) for viewing a graph. For example, a graph interface 260 can be presented on the content sponsor device 210 in response to selection of the user interface control 258. The graph user interface 260 can present, for example, a graph that shows values for performance parameters for the time period indicated in the date range input control 216. In some implementations, the graph user interface 260 includes a presentation of performance parameter values for time units (e.g., days) from the current date up to and including the date range indicated by the date range input control 216. For example, the graph user interface 260 includes plotted data 262 corresponding to impression values for days in the date range of the current date (e.g., Apr. 24, 2014) to the end of the date range indicated by the date range input control 216 (e.g., May 31, 2015). The graph user interface 260 includes plotted data 264 for the same date range as for the plotted data 262 but for unique users. Other representations of the data or portions of the data are possible.

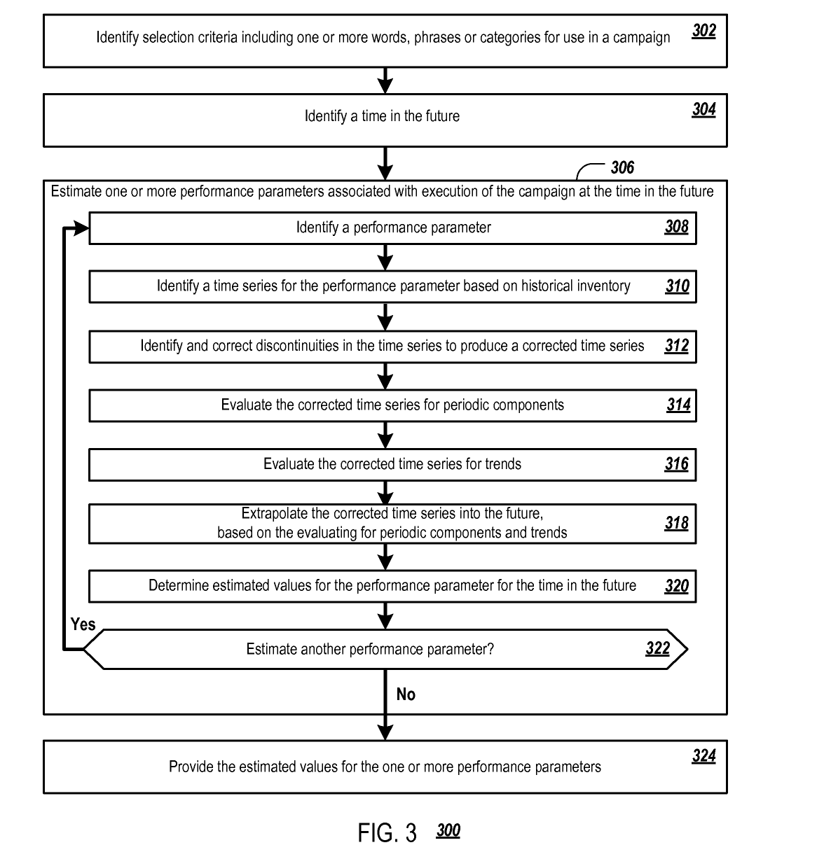

FIG. 3 is a flowchart of an example process 300 for estimating performance parameters. The process 300 can be performed, for example, by the performance estimation system 124 described above with respect to FIG. 1 or the performance estimation system 202 described above with respect to FIG. 2.

Selection criteria including one or more words, phrases or categories for use in a campaign are identified (302). The selection criteria can include, for example, user attributes and/or other attributes associated with a desired impression. The selection criteria can be received, for example, as user input from a content sponsor associated with the campaign. The content sponsor can provide as user input, for example, selection criteria associated with a new or existing campaign. As another example, selection criteria for a campaign can be automatically identified. For example, a system which automatically (e.g., periodically) determines performance estimates can automatically identify a campaign and selection criteria associated with the campaign.

A time in the future is identified (304). The time in the future can be not near term, such as a time that is substantially two to twelve months or more in the future. In some implementations, a time period associated with the time including a starting time and an ending time is identified. The time in the future can be received, for example, as a user input from a content sponsor associated with the campaign. As another example, a system which automatically (e.g., periodically) determines performance estimates can identify a predetermined time in the future. For example, the system can determine a time that is two months, sixth months, nine months, or a year from a current date.

One or more performance parameters associated with execution of the campaign at the time in the future are estimated (306). The performance parameters can include, for example, reach (e.g., number of impressions) and number of unique users associated with the impressions. A set of estimation steps can be performed for each performance parameter. For example, a performance parameter can be identified (308). For example, one of number of impressions or unique users can be identified.

A time series for the performance parameter is identified based on historical inventory (310). The historical inventory can be included, for example, in a historical log. Identifying the time series can include evaluating the historical log, determining for each performance parameter a value for a respective time unit (e.g., one day) associated with the series, and repeating the determining for a predetermined time period in the past.

Discontinuities in the time series are identified and corrected to produce a corrected time series (312). Identifying discontinuities can include comparing adjacent portions of the time series for differences as compared by a measure of improbability with respect to the differences. The measure of improbability can be a measure of both a magnitude and abruptness of the difference.

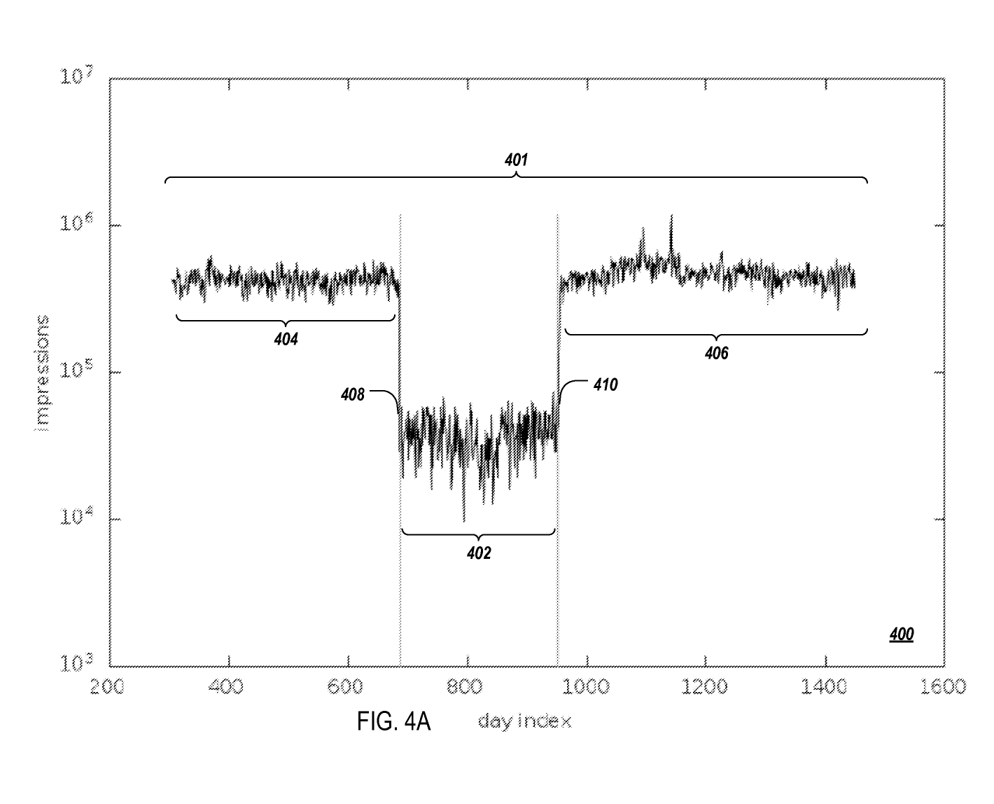

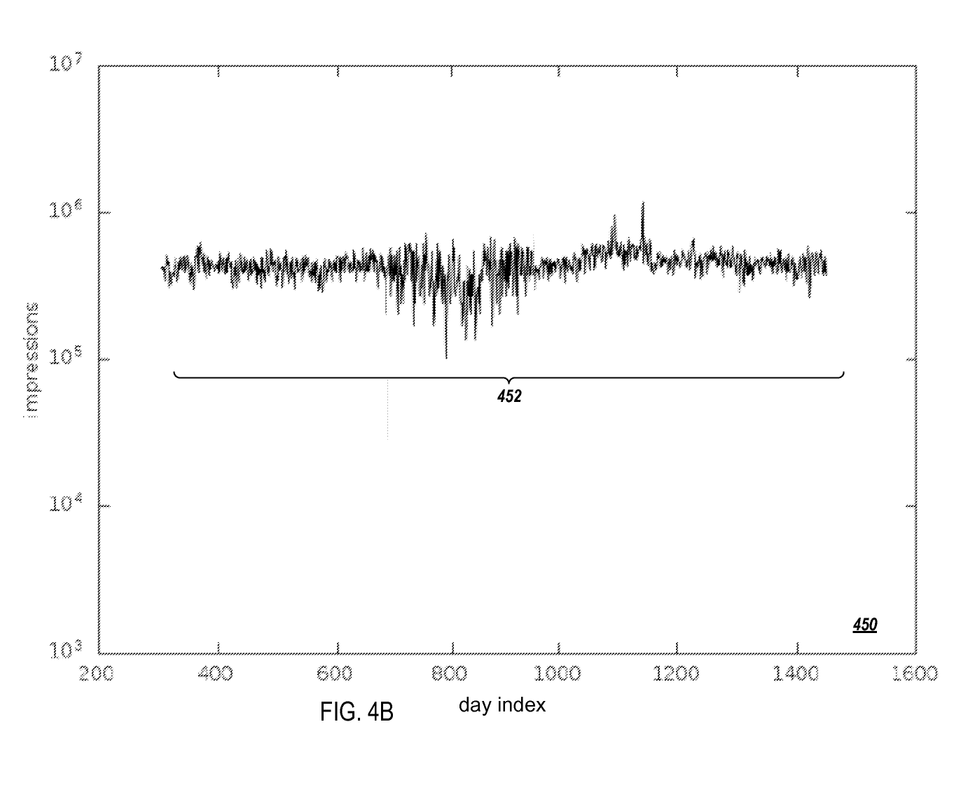

FIG. 4A is a graph 400 of a time series 401 which includes a discontinuity 402. The graph 400 shows impression counts for each day in the time series 401. The discontinuity 402 is a break in the graph 400 between a left segment 404 and a right segment 406. The discontinuity 402 begins at a first break point 408 and ends at a second break point 410. The time series 401 can be corrected to correct for the discontinuity 402, as described above, and as illustrated in FIG. 4B.

FIG. 4B is a graph 450 of a corrected time series 452. The graph 450 shows impression counts for each day in the corrected time series 452. The corrected time series 452 has been corrected to correct for a discontinuity (e.g., the discontinuity 402 described above with respect to FIG. 4A).

Referring again to FIG. 3, the corrected time series is evaluated for periodic components (314). Evaluating for periodic components can include, for example, identifying portions of the corrected time series that include periodic changes in values for the performance parameter and determining a period and change level to be attributed to the period. As another example, evaluating for periodic components can include identifying periodic signals in the corrected time series, characterized by period and temporal span within each period and having statistical significance.

The corrected time series is evaluated for trends (316). Evaluating for trends can include, for example, determining a recent trend based on changes in values for the performance parameter in a recent past and determining a rate of change based on the recent trend. As another example, evaluating for trends can include identifying a trend signal that represents a non-periodic increase or decrease over time.

The corrected time series is extrapolated into the future, based on the evaluating, for periodic components and trends (318). Extrapolation can include, for example, extending each periodic signal and the trend signal in the corrected time series. As another example, extrapolation can include applying one or more regression parameters to combine extended basis vectors based on the periodic and trends signals into a resultant time series which projects out into the future.

Estimated values for the performance parameter are determined for the time in the future (320). For example, the estimated values can be determined based on the resultant time series. For example, when a time period associated with the time is identified the estimated values for the performance parameter can be determined by summing respective values for the performance parameter for the days in the time period.

A determination is made as to whether another performance parameter is to be estimated (322). If another performance parameter is to be estimated, the other performance parameter is identified (308), and steps 310 to 320 are repeated for the other performance parameter.

If another performance parameter is not to be estimated, the estimated values for the one or more performance parameters are provided (324). For example, the estimated values can be provided to the content sponsor.

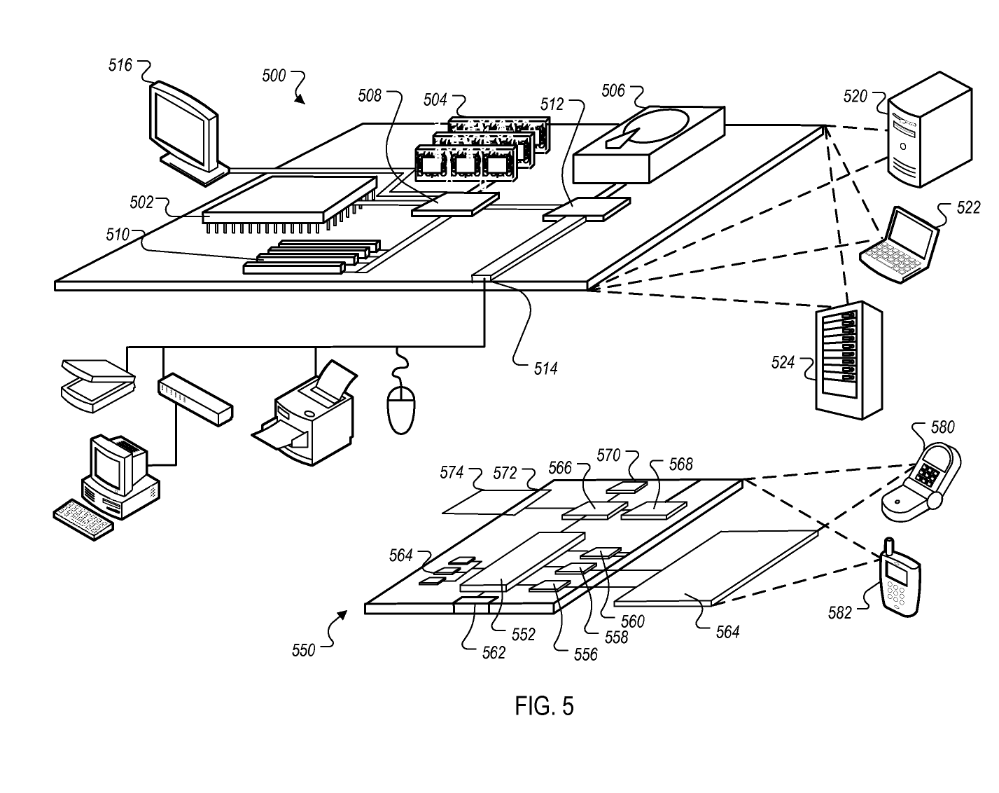

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be illustrative only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a computer-readable medium. The computer-readable medium is not a propagating signal. In one implementation, the memory 504 is a volatile memory unit or units. In another implementation, the memory 504 is a non-volatile memory unit or units.

The storage device 506 is capable of providing mass storage for the computing device 500. In one implementation, the storage device 506 is a computer-readable medium. In various different implementations, the storage device 506 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of duties is illustrative only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can process instructions for execution within the computing device 550, including instructions stored in the memory 564. The processor may also include separate analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD display or an OLED display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication (e.g., via a docking procedure) or for wireless communication (e.g., via Bluetooth® or other such technologies).

The memory 564 stores information within the computing device 550. In one implementation, the memory 564 is a computer-readable medium. In one implementation, the memory 564 is a volatile memory unit or units. In another implementation, the memory 564 is a non-volatile memory unit or units. Expansion memory 574 may also be provided and connected to device 550 through expansion interface 572, which may include, for example, a SIMM card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth®, WiFi, or other such transceiver (not shown). In addition, GPS receiver module 570 may provide additional wireless data to device 550, which may be used as appropriate by applications running on device 550.

Device 550 may also communicate audibly using audio codec 560, which may receive spoken information from a user and convert it to usable digital information. Audio codex 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A method comprising:
identifying selection criteria including one or more words, phrases or categories for use in a campaign;
identifying a time in the future;
estimating one or more performance parameters associated with execution of the campaign at the time in the future including for each performance parameter:
identifying a time series based on historical inventory for the performance parameter;
identifying and correcting for discontinuities in the time series to produce a corrected time series;
evaluating the corrected time series for periodic components;
evaluating the corrected time series for trends;
extrapolating the corrected time series into the future based on the evaluating for periodic components and trends; and
determining, for the time, estimated values for the performance parameter; and
providing the estimated values for the one or more performance parameters.

2. The method of claim 1 wherein identifying the selection criteria and the time includes receiving the selection criteria and the time from a content sponsor associated with the campaign.

3. The method of claim 1 wherein identifying the time includes identifying a time period associated with the time including a starting time and an ending time.

4. The method of claim 1 wherein the time in the future is not near term and is substantially two to twelve months in the future.

5. The method of claim 1 wherein the one or more performance parameters include a number of impressions and number of unique users associated with the impressions.

6. The method of claim 1 wherein identifying a time series includes evaluating a historical log, determining for each performance parameter a value for a respective time unit associated with the series, and repeating the determining for a predetermined time period in the past.

7. The method of claim 6 wherein the time unit is one day.

8. The method of claim 1 wherein identifying discontinuities includes comparing adjacent portions of the time series for differences as compared by a measure of improbability with respect to the differences.

9. The method of claim 8 wherein the measure of improbability is a measure of both a magnitude and abruptness of the difference.

10. The method of claim 1 wherein evaluating the corrected time series for periodic components includes identifying portions of the corrected time series that include periodic changes in values for the performance parameter and determining a period and change level to be attributed to the period.

11. The method of claim 1 wherein evaluating the corrected time series for trends includes determining a recent trend based on changes in values for the performance parameter in a recent past and determining a rate of change based on the recent trend.

12. The method of claim 1 wherein the selection criteria are attributes associated with one or more of targeted users or impressions.

13. The method of claim 1 wherein evaluating the corrected time series for periodic components includes identifying periodic signals in the corrected time series, characterized by period and temporal span within each period and having statistical significance.

14. The method of claim 1 wherein evaluating the corrected time series for trends includes identifying a trend signal that represents a non-periodic increase or decrease over time.

15. The method of claim 14 wherein extrapolating the corrected time series into the future includes extending each periodic signal and the trend signal in the corrected time series.

16. The method of claim 15 further comprising applying one or more regression parameters to combine extended basis vectors based on the periodic and trends signals into a resultant time series which projects out into the future.

17. A computer program product tangibly embodied in a computer-readable storage device and comprising instructions that, when executed by a processor, cause the processor to:
identify selection criteria including one or more words, phrases or categories for use in a campaign;
identify a time in the future;
estimate one or more performance parameters associated with execution of the campaign at the time in the future including for each performance parameter:
identifying a time series based on historical inventory for the performance parameter;
identifying and correcting for discontinuities in the time series to produce a corrected time series;
evaluating the corrected time series for periodic components;
evaluating the corrected time series for trends;
extrapolating the corrected time series into the future based on the evaluating for periodic components and trends; and
determining, for the time, estimated values for the performance parameter; and
provide the estimated values for the one or more performance parameters.

18. The product of claim 17 wherein the time in the future is not near term and is substantially two to twelve months in the future.

19. A system comprising:
one or more processors; and
one or more memory elements including instructions that when executed cause the one or more processors to:
identify selection criteria including one or more words, phrases or categories for use in a campaign;
identify a time in the future;
estimate one or more performance parameters associated with execution of the campaign at the time in the future including for each performance parameter:
identifying a time series based on historical inventory for the performance parameter;
identifying and correcting for discontinuities in the time series to produce a corrected time series;
evaluating the corrected time series for periodic components;
evaluating the corrected time series for trends;
extrapolating the corrected time series into the future based on the evaluating for periodic components and trends; and
determining, for the time, estimated values for the performance parameter; and
provide the estimated values for the one or more performance parameters.

20. The system of claim 19 wherein the time in the future is not near term and is substantially two to twelve months in the future.
